(19) United States
(12) Patent Application Publication
(10) Pub. No.: US 2008/0162516 A1
(43) Pub. Date: Jul. 3, 2008

(54) Relay apparatus and communication method

(75) Inventor: Daisuke Shinomiya, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/000,916

(22) Filed: Dec. 18, 2007

(30) Foreign Application Priority Data
Dec. 19, 2006 (JP) 2006-341317

(51) Int. Cl. G06F 15/177; G06F 17/30; G06F 7/00

(52) U.S. Cl. 707/100; 709/220; 707/E17.044

(57) ABSTRACT

A relay apparatus for relaying communications between information processing units in a network includes: an address check unit for checking for an overlap of an address allocated to each of a plurality of information processing units existing in a network; an address conversion unit for converting an overlapped address detected by the address check unit to thereby create a post-conversion address; and a relay processing unit for relaying communications between the information processing units on the basis of the post-conversion address.

### CROSS REFERENCES TO RELATED APPLICATIONS

This application is based upon and claims the benefit of priority from prior Japanese Patent Application No. 2006-341317, filed Dec. 19, 2006, the entire contents of which are incorporated herein by reference.

### FIELD OF THE INVENTION

The present invention relates to a relay apparatus and an address converting method for converting a MAC (media access control) address allocated to a virtual server.

### DESCRIPTION OF THE RELATED ART

In a network system constructed by virtual servers, there are cases where MAC addresses overlap. The virtual server refers to a plurality of servers virtually constructed in one server by dividing a single physical server resource. The MAC address refers to an ID number inherent to each Ethernet® card. The MAC address also refers to an address expressed by combining a number inherent to each maker managed by IEEE (institute of electrical and electronic engineers), and a number that a maker allocates to each Ethernet® card on the maker's own. Therefore, ordinarily, the MAC address does not overlap.

However, in the network constructed by virtual servers, since the MAC address to be allocated to the virtual server is set by each physical server, there is possibility that a plurality of virtual servers having identical MAC addresses may exist in a network.

As a result, when MAC addresses allocated to different virtual servers overlap with each other, there has been a problem that the transfer to a desired virtual server is impossible.

Furthermore, when communication is performed between virtual servers having identical MAC addresses, there has occurred a problem that a relay apparatus discards a packet as an error.

The following is an example of known document relating to the MAC address conversion.

[Patent Document 1] Japanese Unexamined Patent Application Publication No. 2004-304371

However, even in the switching device in the above document, communications cannot be appropriately established when identical MAC addresses exist in the network.

### SUMMARY

The object of the present invention is to reliably establish communications even if there exist a plurality of virtual servers having an identical MAC address in the network.

According to an aspect of embodiments of the present invention, a relay apparatus for relaying communications between information processing units includes: an address check unit that checks for an overlap of an address allocated to each of a plurality of information processing units existing in a network; an address conversion unit that converts the overlapped address detected by the address check unit to thereby create a post-conversion address; and a relay processing unit that relays communications between the information processing units, based on the post-conversion address.

### BRIEF DESCRIPTION OF THE DRAWINGS

FIG. 1 is a conceptual diagram of a network system 100 according to the present embodiment.

FIG. 2 is a sequence diagram of communications in the network system 100 according to this embodiment.

FIG. 3 is a sequence diagram of communications in the network system 100 according to this embodiment.

FIG. 4 is a hard block diagram of a relay apparatus 101 according to this embodiment.

FIG. 5 is a MAT function on/off determination flowchart in a MAT function on/off check unit 402.

FIG. 6 is a MAT function on/off determination flowchart in a MAT function on/off check unit 407.

FIG. 7 is an ARP table 700 according to this embodiment.

FIG. 8 is a MAT table 800 according to this embodiment.

FIG. 9 is a MAC address table 900 according to this embodiment.

FIG. 10 is a conceptual diagram of a network system 1000 according to this embodiment.

FIG. 11 is a sequence diagram of communications in the network system 1000 according to this embodiment.

FIG. 12 is a sequence diagram of communications in the network system 1000 according to this embodiment.

FIG. 13 is a sequence diagram of communications in the network system 1000 according to this embodiment.

FIG. 14 is a sequence diagram of communications in the network system 1000 according to this embodiment.

FIG. 15 is a hard block diagram of a relay apparatus 1001 according to this embodiment.

FIG. 16 is an ARP table 1600 according to this embodiment.

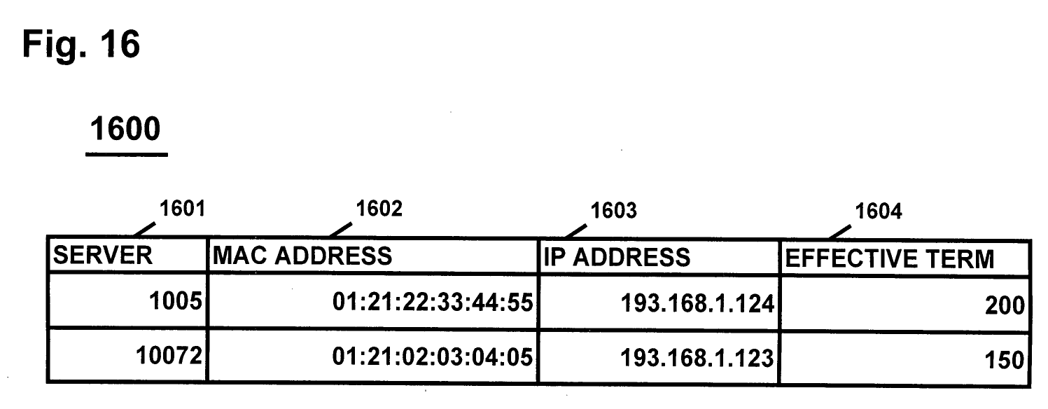

FIG. 17 is a MAC address table 1700 according to this embodiment.

FIG. 18 is a MAT table 1800 according to this embodiment.

FIG. 19 is a MAC address list table 1900 according to this embodiment.

### DESCRIPTION OF THE PREFERRED EMBODIMENTS

### First Embodiment

The present embodiment is an example of relay apparatus 101 that converts a possibly overlapping MAC address of a virtual server. The relay apparatus 101 performs the conversion of a MAC address in a static manner. “Performing the conversion of a MAC address in a static manner” means that, out of a packet received from a predetermined port, a MAC address alone is converted.

[Network System 100]

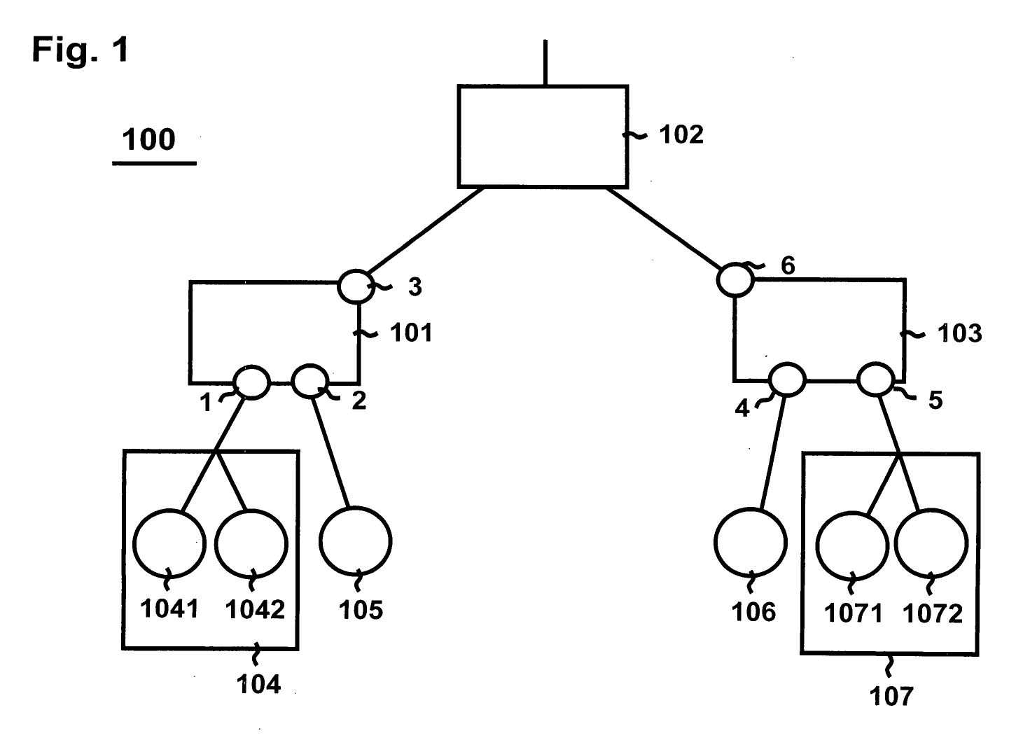

FIG. 1 is a conceptual diagram of a network system 100 according to this embodiment.

The network system 100 is constructed by relay apparatuses 101, 102, and 103, and end systems 104, 105, 106, and 107. End systems 104, 105, 106, and 107, which are servers or personal computers, are apparatuses capable of communicating with other information processing units via the network. Hereinafter, the end systems 104, 105, 106, and 107 are each referred to as a server. The server 104 incorporates therein virtual servers 1041 and 1042. The network system 100 is a layer 2 network system or the like, and performs layer 2 network communications by designating MAC addresses owned by the servers 104, 105, 106, and 107 as destination addresses and source addresses.

[Relay Apparatuses]

The relay apparatus 101 in this embodiment is a layer 2 switch or the like, and is a relay apparatus of Ethernet®, determining the destination of a packet by a MAC address. The relay apparatus 101 may also be a layer 3 switch that is a relay apparatus having a bridge function of the layer 2. Likewise, the relay apparatuses 102 and 103 are also layer 2 switch or the like. The relay apparatus 101 includes ports 1, 2, and 3. The relay apparatus 101 is connected to the server 104 via the port 1. Likewise, the relay apparatus 101 is connected to the server 105 via the port 2. The relay apparatus 101 is connected to the relay apparatus 102 via the port 3. Also, the relay apparatus 103 includes ports 4, 5, and 6. The relay apparatus 103 is connected to the server 106 via the port 4. Likewise, the relay apparatus 103 is connected to the server 107 via the port 5. The relay apparatus 103 is connected to the relay apparatus 102 via the port 6.

Because the relay apparatus 102 is not connected to the servers 104, 105, 106, and 107, it is a relay apparatus that does not perform a MAC address conversion, and that relays packets communicated between the relay apparatus 101 and the relay apparatus 103 without converting a MAC address.

[Servers]

The server 104 incorporates therein virtual servers 1041 and 1042. The server 104 allocates an IP address and a MAC address to each of the virtual servers 1041 and 1042. MAC addresses of the virtual servers 1041 and 1042 are generated on the basis of IP addresses of the virtual servers 1041 and 1042. The server 104 processes the respective IP address to be allocated to the virtual servers 1041 and 1042 by a definite algorithm, and generates low-order 24 bits of the MAC addresses. Likewise, the server 107 incorporates therein virtual servers 1071 and 1072. The server 107 allocates an IP address and a MAC address to each of the virtual servers 1071 and 1072.

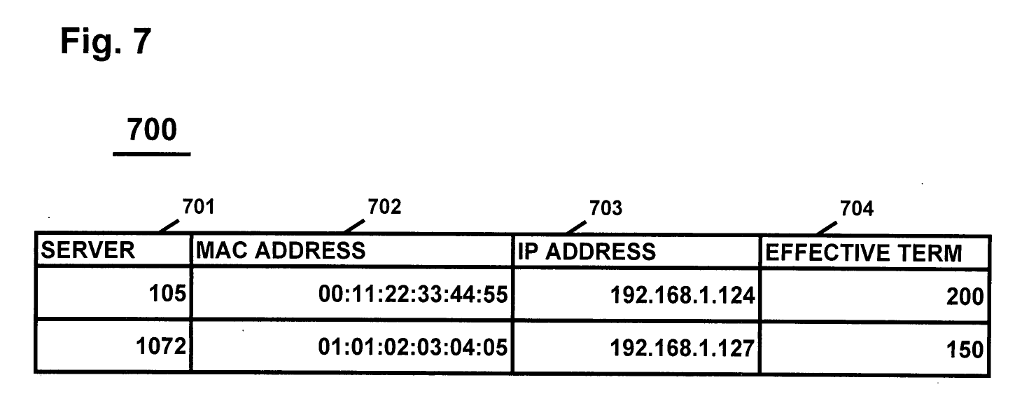

The server 104 has an ARP (address resolution protocol) table 700 shown in FIG. 7. The ARP table 700 shows correspondence relationships between an IP address and a MAC address of each of another server 105 and the virtual server 1072 existing in the network system 100. Here, the ARP table refers to a table that shows correspondence relationships between the MAC address and the IP address of each of the servers and the virtual servers or the like existing in a predetermined network system. The virtual servers 1041 and 1042 each have a learning function of restoring, in the ARP table, the MAC addresses of the servers with which they have performed communication in the past, to thereby update the ARP table. As a result, when the MAC address of a server with which communication is desired to be performed exists in the ARP table 700, the virtual servers 1041 and 1042 each transmit a packet with a desired MAC address in the ARP table 700 as a destination. In this embodiment, the virtual servers 1041 and 1042 each make reference to the identical ARP table 700 to thereby perform communications with servers 105, 106, 1071, and 1072 in the network. The ARP table 700 also shows validity periods of the IP address and the MAC address allocated to each of the servers 105, 106, 1071, and 1072.

When the virtual server 1041 determines that there is no desired MAC address in the ARP table 700, it transmits, by broadcast, an ARP request packet to all servers 1042, 105, 106, and 107 existing in the network system 100. The ARP request packet is a packet comprising information on the IP address of a destination, the IP address of a source, and the MAC address of the source. Since the server 1041 performs communications through the intermediary of the relay apparatuses 101, 102, and 103 such as layer 2 or the like, it cannot perform communications without knowing the MAC address of a destination. This is because the server 1041 must designate the MAC address of a communication partner in the destination field of a packet.

Each of the servers 1042, 105, 106, and 107 that have received the ARP packet request packet by broadcast determines whether its own IP address conforms to the destination IP address in the ARP packet request. The server of which own IP address conforms to the destination IP address in the ARP packet request transmits an ARP reply packet including its own MAC address to the virtual server 1041. This allows the virtual server 1041 to acquire the MAC address of the communication partner.

When the virtual server 1041 attempts to transmit an ARP request packet to the virtual server 1042, the virtual server 1041 transmits it to the virtual server 1041 via a virtual switch inside the server 104. This is because the virtual server 1041 and the virtual server 1042 exist in the identical physical server 104.

When the virtual server 104 transmits an ARP request packet to the servers 105 and 106, and the virtual servers 1071 and 1072, the relay apparatus 101 converts a source MAC address (MAC address allocated to the virtual server 1041) of the ARP request packet, into another MAC address. Then, the relay apparatus 101 transmits the ARP request packet with the source MAC address converted, to the servers 105 and 106, and the virtual servers 1071 and 1072. In short, in this embodiment, the MAC address received from the server 104 that is connected to the relay apparatus 101 and that incorporates the virtual servers 1041 and 1042, is converted. In other words, in this embodiment, the relay apparatus converts possibly overlapping MAC addresses.

The server 104 allocates a MAC address to each of the virtual servers 1041 and 1042. Here, the MAC address owned by the virtual server 1041 and that owned by the virtual server 1042 are mutually different MAC addresses.

[Communication Sequence in Network System 100]

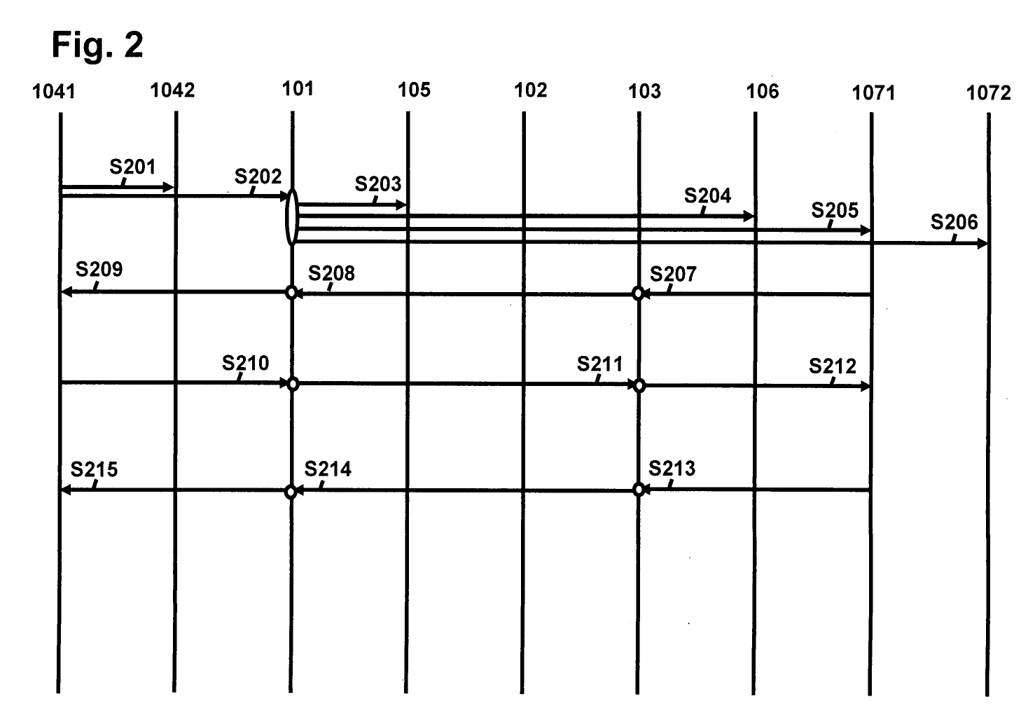

FIG. 2 is a sequence diagram of communications in the network system 100 according to this embodiment. Packet communications between the virtual server 1041 and the virtual server 1071 will be described below. In this embodiment, when the server 104 is connected and communication is to be started, ARP processing is performed. The ARP processing refers to processing wherein a server connected to the network system transmits an ARP request packet, and receives an ARP reply packet from another server in the network system.

First, the virtual server 1041 makes reference to the ARP table 700. The MAC address of the virtual server 1071 has not been recorded in the ARP table 700, and so the virtual server 1041 transmits, by broadcast, an ARP request packet to each of the virtual servers 1042, 1071, and 1072, and the servers 105 and 106 in the network system 100 (S201 and S202). The ARP request packet includes information on the IP address [192. 168. 1.126] of the virtual server 1071 with which communication is desired to be performed, the IP address [192. 168. 1.122] of the virtual server 1041 as a source, and the MAC address [00: 22: 33: 44: 55: 66] of the virtual server 1041. The servers 105 and 106, and the virtual servers 1071 and 1072 receive the ARP request packet via the relay apparatus 101. The relay apparatus 101 converts the MAC address [00: 22: 33: 44: 55: 66] of the virtual server 1041 in the ARP request packet into [01: 22: 33: 44: 55: 66], and transmits the ARP request packet to the servers 105 and 106, and the virtual servers 1071 and 1072 (S203 to S206). Each of the virtual servers 1042, 1071 and 1072, and the servers 105 and 106 determines whether its own IP address is the IP address [192. 168. 1.126] included in the ARP request packet. The virtual server 1071 determines the IP address [192. 168. 1.126] included in the ARP request packet conforms to the IP address owned by the virtual server 1071 itself. Then, the virtual server 1071 returns an ARP reply packet to the virtual server 1041 via the relay apparatuses 103, 102, and 101 (S207-S209). The ARP reply packet includes the MAC address [00: 22: 33: 44: 55: 66] of the virtual server 1071. The relay apparatus 103 converts the MAC address [00: 22: 33: 44: 55: 66] of the virtual server 1071 included in the ARP reply packet into [00: 22: 33: 44: 55: 60]. Here, the MAC address [00: 22: 33: 44: 55: 66] of the virtual server 1071 is a source MAC address of the ARP reply packet. The relay apparatus 101 converts a destination MAC address [01: 22: 33: 44: 55: 66] included in the ARP reply packet into the MAC address [00: 22: 33: 44: 55: 66] of the virtual server 1041. The virtual server 1041 acquires the MAC address [00: 22: 33: 44: 55: 60] of the virtual server 1071 converted by the relay apparatus 103, and records the MAC address [00: 22: 33: 44: 55: 60] of the virtual server 1071 in the ARP table 700 to thereby update it. The virtual server 1041 transmits a packet to the virtual server 1071 with the MAC address [00: 22: 33: 44: 55: 60] as a destination address, and performs communications with the virtual server 1071 (S210-S212). The virtual server 1071 also transmits a packet to the virtual server 1071 with the MAC address [01: 22: 33: 44: 55: 66] as a destination address, and performs communications with the virtual server 1041 (S213-S215).

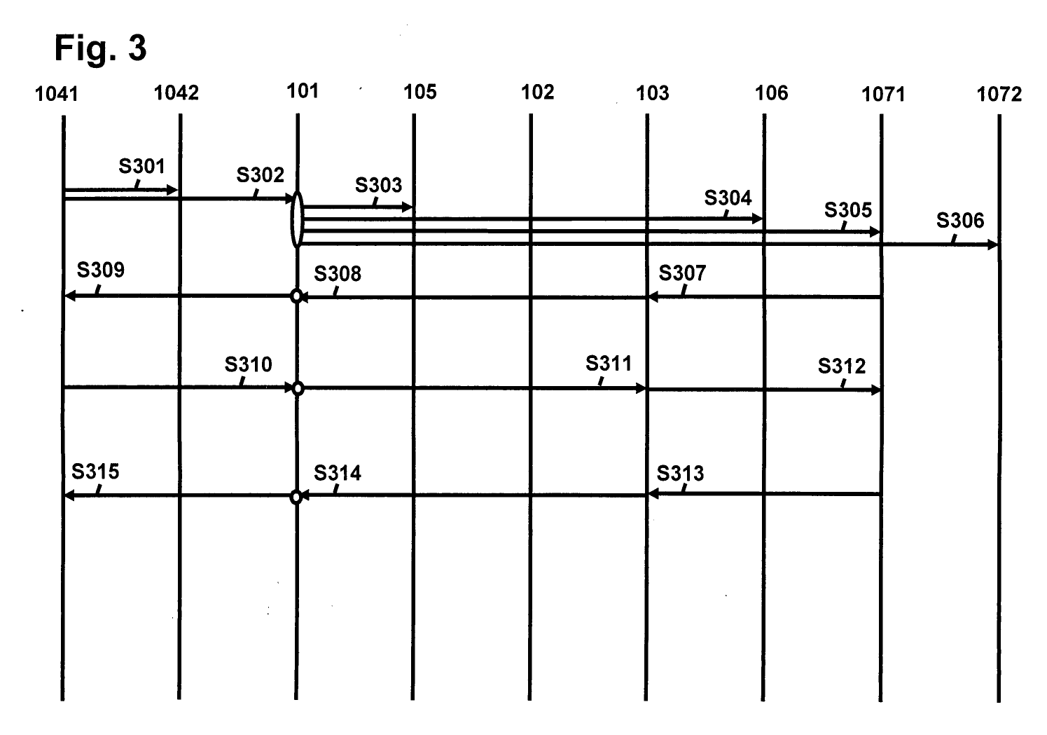

FIG. 3 is also a sequence diagram of communications in the network system 100 according to this embodiment. Packet communications between the virtual server 1041 and the server 106 will be described below.

The virtual server 1041 makes reference to the ARP table 700. The MAC address of the virtual server 106 has not been recorded in the ARP table 700, and so the virtual server 1041 transmits, by broadcast, an ARP request packet to each of the virtual servers 1042, 1071, and 1072, and the servers 105 and 106 in the network system 100 (S301 and S302). The ARP request packet includes information on the IP address [192. 168. 1.125] of the virtual server 106 with which communication is desired to be performed, the IP address [192. 168. 1.122] of the virtual server 1041 as a source, and the MAC address [00: 22: 33: 44: 55: 66] of the virtual server 1041. The servers 105 and 106, and the virtual servers 1071 and 1072 receive the ARP request packet via the relay apparatus 101. The relay apparatus 101 converts the MAC address [00: 22: 33: 44: 55: 66] of the virtual server 1041 in the ARP request packet into [01: 22: 33: 44: 55: 66], and transmits the ARP request packet to the servers 105 and 106, and the virtual servers 1071 and 1072 (S303 to S306). Each of the virtual servers 1042, 1071 and 1072, and the servers 105 and 106 determines whether its own IP address is the IP address [192. 168. 1.125] included in the ARP request packet. The virtual server 106 determines the IP address [192. 168. 1.125] included in the ARP request packet conforms to the IP address owned by the virtual server 106 itself. Then, the virtual server 106 returns an ARP reply packet to the virtual server 1041 via the relay apparatuses 103, 102, and 101 (S307-S309). The ARP reply packet includes the MAC address [01: 11: 22: 33: 44: 66] of the virtual server 106. The relay apparatus 103 does not convert the MAC address [01: 11: 22: 33: 44: 66] of the server 106. The relay apparatus 101 converts a destination MAC address [01: 22: 33: 44: 55: 66] included in the ARP reply packet into the MAC address [00: 22: 33: 44: 55: 66] of the virtual server 1041. The virtual server 1041 acquires the MAC address [01: 11: 22: 33: 44: 66] of the server 106, and records the MAC address [01: 11: 22: 33: 44: 66] of the server 106 in the ARP table 700 to thereby update it. The virtual server 1041 transmits a packet to the server 106 with the MAC address [01: 11: 22: 33: 44: 66] as a destination address, and performs communications with the virtual server 106 (S310-S312). The server 106 also performs communications with the virtual server 1041 with the MAC address [01: 22: 33: 44: 55: 66] as a destination address, (S313-S315).

[Hard Configuration of Relay Apparatus 101]

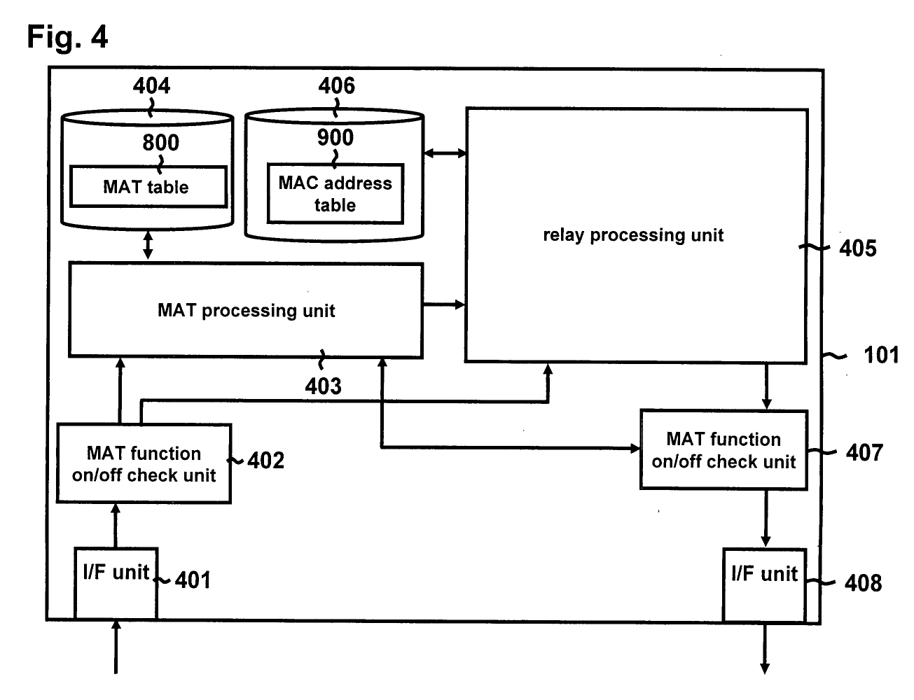

FIG. 4 is a hard block diagram of the relay apparatus 101 according to this embodiment.

The relay apparatus 101 comprises interface (I/F) units 401 and 408; MAT (MAC address translation) function on/off check units 402 and 407; a MAT processing unit 403; a storage unit 404; a relay processing unit 405; and a storage 406.

The relay apparatus 101 receives a packet in the interface (I/F) unit 401. The I/F unit 401 receives a packet from each of the virtual servers 1041, 1042, 1071, and 1072, and the servers 105 and 106. The I/F unit 401 transfers the received packets to the MAT function on/off check unit 402.

The MAT function on/off check unit 402 checks a MAT function on/off at a port for receiving packets. If the MAT function on/off check unit 402 determines the MAT function to be on, it transfers the packets to the MAT processing unit 403. If the MAT function on/off check unit 402 determines the MAT function to be off, it transfers the packets to the relay processing unit 405. Here, the MAT function refers to a function of converting a MAC address existing in the packet.

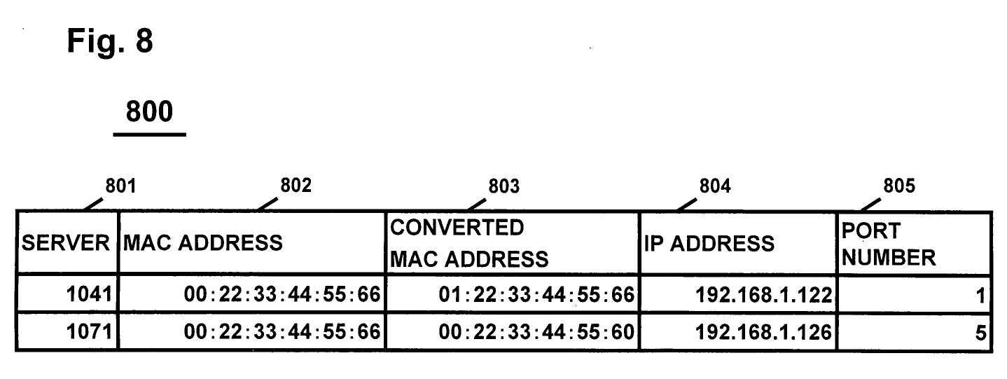

The MAT processing unit 403 makes reference to MAT table 800 of the storage unit 404 to thereby convert a source address located in the header portion of the packet. The MAT processing unit 403 makes reference to the MAT table 800 shown in FIG. 8, and when a MAC address to be converted, corresponding to the MAC address of a conversion target has been recorded in the MAT table 800, the MAT processing unit 403 converts source/destination MAC addresses of the packet into MAC addresses converted based on the MAT table 800. Here, the MAT table is a table relating MAC addresses that are conversion targets in the MAT function on/off check units 402 and 407, to the post-conversion addresses that have been converted from the pertinent MAT addresses by the MAT processing unit 403. If there exists no MAC address to be converted in the MAT table 800, the MAT processing unit 403 generates a MAC address to be converted. The MAT processing unit 403 relates the generated MAC address to the MAC address of a conversion target, and records it in the MAT table 800.

In a packet including a source address in DATA of the packet, the MAT processing unit 403 makes reference to the MAT table 800 of the storage unit 404 to thereby convert also the source address in the DATA.

By the MAT function on/off check unit 402 determining the presence/absence of the conversion of a MAC address only regarding a packet received from a predetermined port, it is possible to efficiently perform the conversion processing with respect to the MAC address. The MAT function on/off check unit 402 does not convert a source address received from the port that is connected with the server 105 incorporating no virtual server. This eliminates the need to convert a MAC address free from the possibility of overlapping, thereby allowing communications to be performed without reducing communication speed. Also, the destination MAC address of a packet of which the destination is broadcasted, is not converted. This is because the presence-absence of an overlap is left out of consideration because of the broadcast.

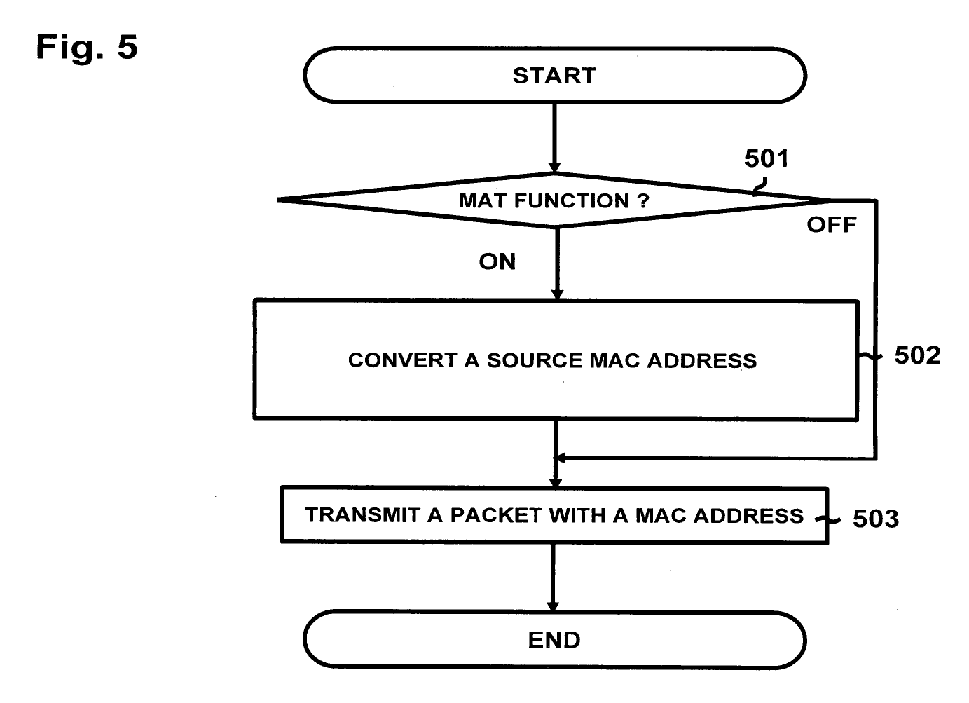

FIG. 5 is a MAT function on/off determination flowchart in the MAT function on/off check unit 402. The MAT function on/off check unit 402 checks on/off of MAT function in a port for receiving packets (S501).

When the MAT function is on, the MAT processing unit 403 makes reference to the MAT table 800 to thereby convert a source MAC address in the packet (S502). When a MAC address is included in the DATA of the packet, the MAT processing unit 403 converts also the MAC address in the DATA.

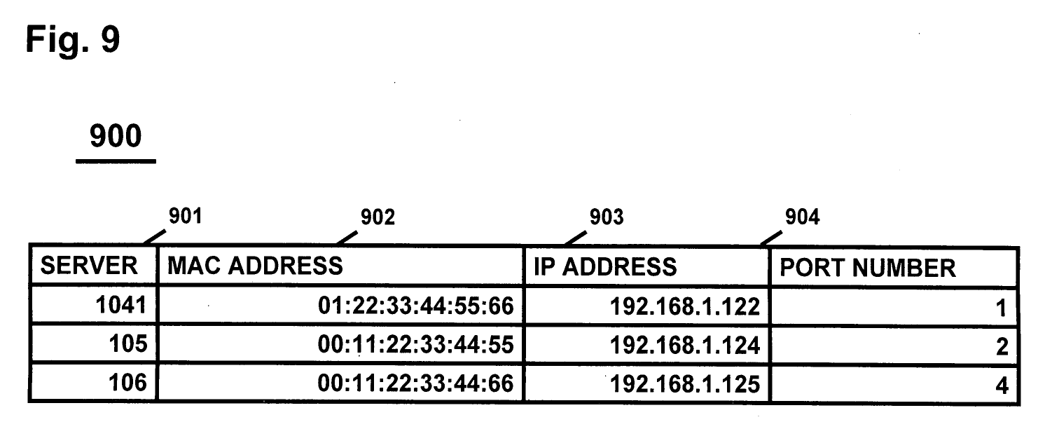

The relay processing unit 405 makes reference to a MAC address table 900 shown in FIG. 9, to thereby transmit a packet with a MAC address converted, from the port number corresponding to the source MAC address via the I/F unit 408 (S503). When the MAT function is off, the relay processing unit 405 makes reference to the MAC address table 900 to thereby transmit a packet from the port number corresponding to the source MAC address via the I/F unit 408 (S503). Here, the MAC address table is a table showing correspondence relationships between post-conversion addresses and port numbers that identify servers and virtual servers connected to a relay apparatus having the MAC address table.

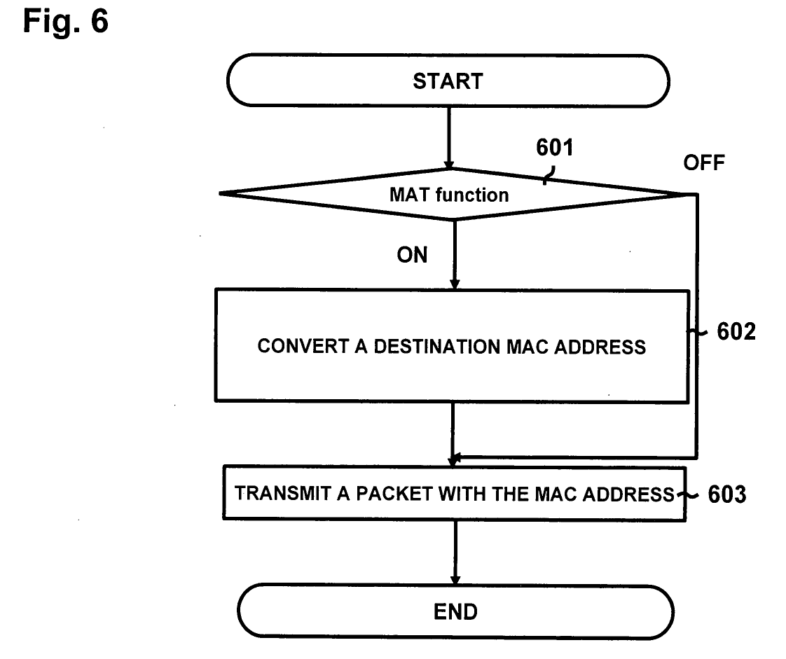

FIG. 6 is a MAT function on/off determination flowchart in the MAT function on/off check unit 407. The MAT function on/off check unit 407 checks on/off of the MAT function in the port for transmitting packets (S601).

When the MAT function is on, the MAT processing unit 403 makes reference to the MAT table to thereby convert a destination MAC address in the packet (S602). When a MAC address is included in the DATA of the packet, the MAT processing unit 403 converts also the MAC address in the DATA.

The relay processing unit 405 makes reference to the MAC address table 900 to thereby transmit a packet with the MAC address converted, from the port number corresponding to the destination MAC address via the I/F unit 408 (S603). When the MAT function is off, the relay processing unit 405 makes reference to the MAC address table 900 to thereby transmit a packet from the port number corresponding to the destination MAC address via the I/F unit 408 (S603).

As well as performing conversion processing with respect to MAC addresses, the MAT processing unit 403 records, in the MAT table 800, a MAC address before conversion, a MAC address after conversion, and an IP address corresponding to the MAC address that is subjected to the conversion processing. Here, the recording of MAC addresses or the like in the MAT table 800, to be performed by the MAT processing unit 403 is conducted when the pertinent MAC addresses or the like have not been recorded in the MAT table 800.

As a result, at a second time or later, the MAT processing unit 403 can shorten conversion processing with respect to MAC address by making reference to the MAT table 800, which allows the conversion processing with respect to MAC address to be efficiently performed.

The MAT processing unit 403 transfers a packet with a source MAC address converted, to the relay processing unit 405. The relay processing unit 405 makes reference to the MAC address table 900 stored in the storage unit 406 to thereby transmit the packet from the port number corresponding to the source MAC address via the I/F unit 408.

FIG. 9 is the MAC address table 900 according to this embodiment. The relay apparatus 101 also has a learning function of updating the MAC address table 900, and records, in the MAC address table 900, correspondence relationships between MAC addresses that have been once used for relay processing and ports.

In the same manner, the relay apparatus 103 converts the MAC address of a packet that is to be received from a port connected with the virtual servers 1071 and 1072 or that is to be transmitted to the port. That is, the MAT processing unit in the relay apparatus 103 converts the source MAC address of the packet to be received from the virtual servers 1071 and 1072 into another MAC address. The MAT processing unit in the relay apparatus 103 converts the destination MAC address of the packet to be transmitted to the virtual servers 1071 and 1072 into another MAC address.

According to the relay apparatuses 101 and 103 in this embodiment, even under the environment that is located in the network including virtual servers and the like, and that has a relatively high possibility that MAC addresses overlap, it is possible to realize high-reliability communications without causing a communication failure.

The relay apparatuses 101, 102, and 103 may be configured so as to notify a management server (not shown) that a MAC address is overlapped in the network 100, by utilizing SNMP (simple network management protocol) or the like.

In this embodiment, the MAT function on/off check units 402 and 407; the MAT processing unit 403; and the relay processing unit 405 have hard configurations physically different from one another, but processings performed by these units may be functionally implemented by a single hard. Also, in this embodiment, the MAT table 800 and the MAC address table 900 are stored in the storage unit 404 and the storage unit 406 that are physically different from each other, but the MAT table 800 and the MAC address table 900 may be stored in a single hard.

### Second Embodiment

This embodiment is an embodiment of a relay 1001 that determines whether MAC addresses are overlapped in a network 1000, and that, if so, converts overlapped MAC addresses. The relay apparatus 701 performs the conversion of MAC addresses in a dynamic manner. “Performing the conversion of MAC addresses in a dynamic manner” means that the relay apparatus 701 checks for overlaps of the MAC addresses, and if any, it converts overlapped MAC addresses into other new MAC addresses.

[Network System 1000]

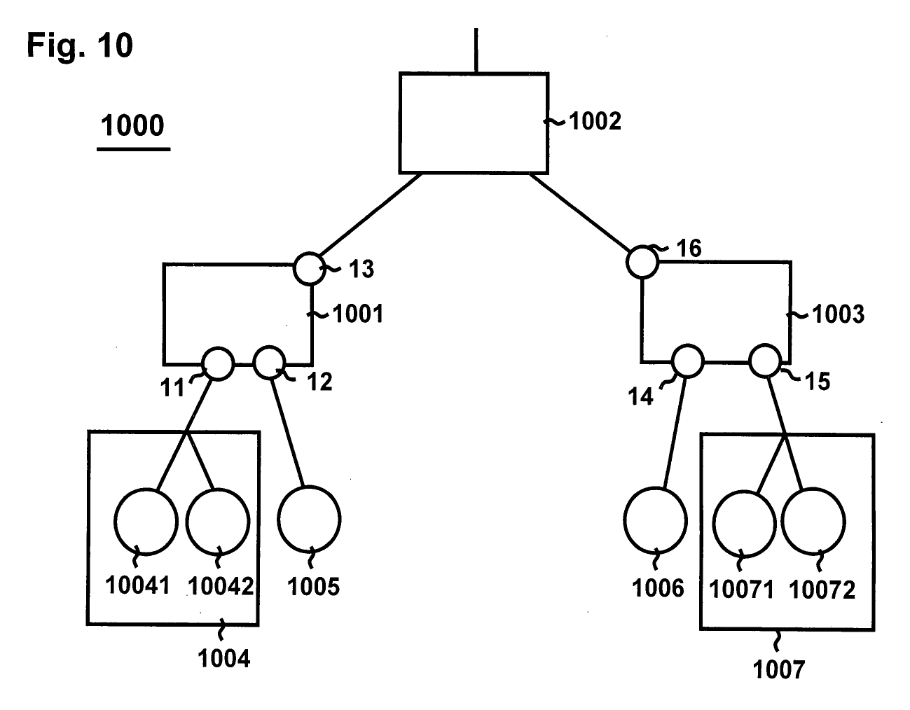

FIG. 10 is a conceptual diagram of the network system 1000 according to this embodiment.

The network system 100 is constructed by relay apparatuses 1001, 1002, and 1003, and servers 1004, 1005, 1006, and 1007.

The server 1004 incorporates therein virtual servers 10041, 10042. Likewise, the server 1007 incorporates therein virtual servers 10071, 10072. The network system 1000 is layer 2 network system or the like, and performs layer 2 network communications by designating MAC addresses owned by the servers 1004, 1005, 1006, and 1007 as destination addresses and source addresses. The network system 1000 is layer 2 network system or the like, and performs layer 2 network communications by designating MAC addresses owned by the servers 1004, 1005, 1006, and 1007 as destination addresses and source addresses.

[Relay Apparatuses]

The relay apparatus 1001 in this embodiment is a layer 2 switch or the like, and is a relay apparatus of Ethernet®, determining the destination of a packet by a MAC address. Likewise, the relay apparatuses 1002 and 1003 are each layer 2 switch or the like.

The relay apparatus 1002, which is not connected to the servers 1004, 1005, 1006, and 1007, is a relay apparatus that does not perform conversion of a MAC address and that relays packets communicated between the relay apparatus 1001 and the relay apparatus 1003 without converting the MAC address. The relay apparatus 1001 includes ports 11, 12, and 13. The relay apparatus 1001 is connected to the server 1004 via the port 11. Likewise, the relay apparatus 1001 is connected to the server 1005 via the port 12. The relay apparatus 1001 is connected to the relay apparatus 1002 via the port 13. Also, the relay apparatus 1003 includes ports 14, 15, and 16. The relay apparatus 1003 is connected to the server 1006 via the port 14. Likewise, the relay apparatus 1003 is connected to the server 1007 via the port 15. The relay apparatus 1003 is connected to the relay apparatus 1002 via the port 16.

[Servers]

The server 1004 incorporates therein virtual servers 10041 and 10042. The server 1004 allocates an IP address and a MAC address to each of the virtual servers 10041 and 10042. MAC addresses of the virtual servers 10041 and 10042 are generated on the basis of IP addresses of the virtual servers 10041 and 10042. The server 1004 processes the respective IP addresses to be allocated to the virtual server 10041 and 10042 by a definite algorithm, and generates low-order 24 bits of the MAC addresses. Likewise, the server 1007 also allocates an IP address and a MAC address to each of the virtual servers 10071 and 10072.

The server 1004 has an ARP table 1600. The ARP table 1600 is a table showing correspondence relationships between IP addresses and MAC addresses of the other servers 1005 and 1006, and the virtual servers 10071 and 10072 existing in the network system 1000. The virtual servers 10041 and 10042 each have a learning function of restoring, in the ARP table, the MAC addresses of servers with which they have performed communication in the past, to thereby update the ARP table.

As a result, when the MAC address of a server with which communication is desired to be performed exists in the ARP table 1600, the virtual servers 10041 and 10042 each transmit a packet with a desired MAC address in the ARP table 1600 as a destination. In this embodiment, the virtual servers 10041 and 10042 each make reference to the identical ARP table 1600 to thereby perform communications with servers 1005, 1006, 10071, and 10072 in the network. The ARP table 1600 also stores validity periods of the IP address and the MAC address allocated to each of the servers 1005, 1006, 10071, and 10072.

When the virtual server 10041 determines that there is no desired MAC address in the ARP table 1600, it transmits, by broadcast, an ARP request packet to all servers 10042, 1005, 1006, and 1007 existing in the network system 1000. The virtual servers 10042 that have received the ARP packet request packet by broadcast determines whether its own IP address conforms to the destination IP address in the ARP packet request. The ARP request packet to be transmitted to the server 1005 is transmitted to the server 1005 via the relay apparatus 1001. Likewise, the ARP request packet to be transmitted to each of the server 1006, and the virtual servers 10071 and 10072, is transmitted to each of the server 1006, and the virtual servers 10071 and 10072 via the relay apparatus 1001. Prior to transmitting the ARP request packet to each of the servers 1005 and 1006, and the virtual servers 10071 and 10072, the relay apparatus 1001 checks whether a source MAC address (MAC address of virtual server 10041) included in the ARP request packet is overlapped in the network system 1000. The relay apparatus 1001 transmits a ping to each of the servers 1005 and 1006, and the virtual server 10071 and 10072. The servers 1005 and 1006, and the virtual server 10071 and 10072 each returns an echo reply packet to the relay apparatus 1001. The echo reply packets received from the servers 1005 and 1006, and the virtual server 10071 and 10072 each includes a respective one of the MAC addresses. After having extracted the MAC addresses from the respective echo reply packets, the relay apparatus 1001 discards these echo reply packets.

When the relay apparatus 1001 determines that there exists no MAC address overlapping with the source MAC address of the ARP request packet, in the network system 1000, the relay apparatus 1001 transmits the ARP request packet to each of the server 1005 and 1006, and the virtual server 10071 and 10072 without converting the source MAC address of the ARP request packet. On the other hand, when the relay apparatus 1001 determines that there exists a MAC address overlapping with the source MAC address of the ARP request packet, in the network system 1000, the relay apparatus 1001 converts the source MAC address of the ARP request packet, and transmits the ARP request packet to each of the servers 1005 and 1006, and the virtual servers 10071 and 10072.

The server of which own IP address conforms to the destination IP address in the ARP packet request transmits an ARP reply packet including its own MAC address to the virtual server 10041. This allows the virtual server 10041 to acquire the MAC address of a communication partner.

In this embodiment, the relays 1001 and 1003 determine whether the MAC address is overlapped in the network system 1000, and if so, they convert the MAC address.

[Communication Sequence in Network System 1000]

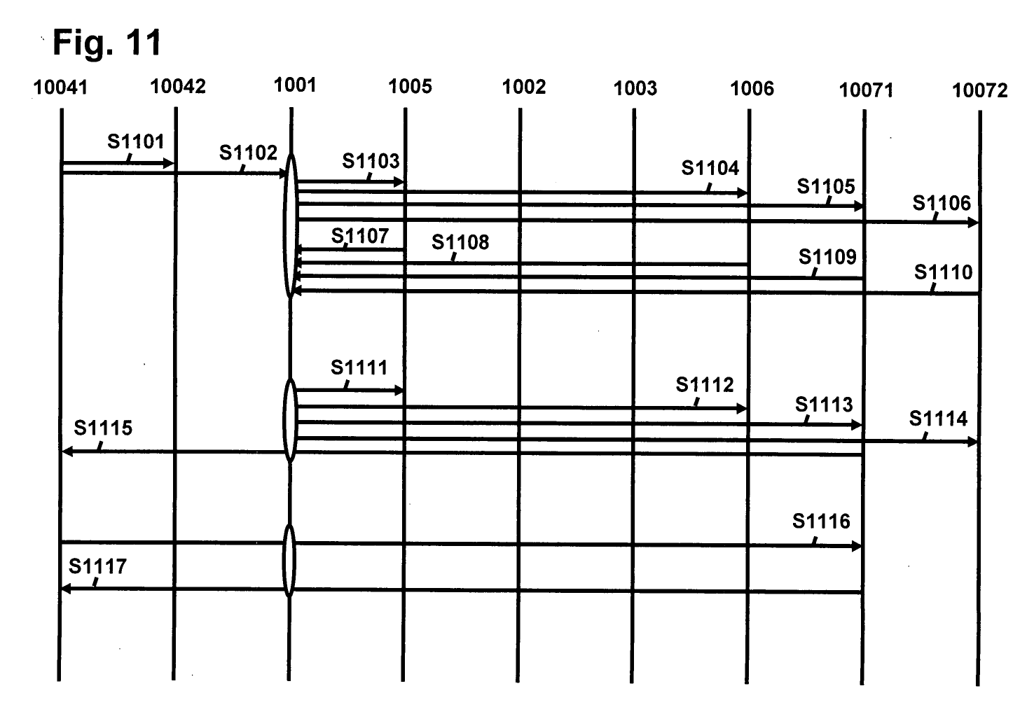

FIG. 11 is a sequence diagram of communications in the network system 1000 according to this embodiment. Packet communications between the virtual server 10041 and the virtual server 10071 will be described below. This figure is a sequence diagram in the case where there is no overlap of MAC address in the network system 1000.

In this embodiment, when the server 1004 is connected and communication is to be started, ARP processing is performed. The ARP processing refers to processing wherein a server connected to the network system transmits an ARP request packet, and receives an ARP reply packet from another server in the network system.

First, the virtual server 10041 makes reference to the ARP table 1600. The MAC address of the virtual server 10071 has not been recorded in the ARP table 1600, and so the virtual server 10041 transmits, by broadcast, an ARP request packet to each of the virtual servers 10042, 10071, and 10072, and the servers 1005 and 1006 in the network system 1000 (S1101 and S1102). The ARP request packet includes information on the IP address [193. 168. 1.126] of the virtual server 10071 with which communication is desired to be performed, the IP address [193. 168. 1.122] of the virtual server 10041 as a source, and the MAC address [00: 21: 33: 44: 55: 66] of the virtual server 10041.

The servers 1005 and 1006, and the virtual servers 10071 and 10072 receive the ARP request packet via the relay apparatus 1001. Prior to transmitting the ARP request packet to the servers 1005 and 1006, and the virtual servers 10071 and 10072, the relay apparatus 1001 transmits a ping to each of the servers 1005 and 1006, and the virtual servers 10071 and 10072 (S1103 to 1106). Here, the purpose of transmitting the ping is to check whether the source MAC address [00: 21: 33: 44: 55: 66] (the MAC address of the virtual server 10041) included in the ARP request packet is overlapped in the network system 1000. Also, the source IP address of the ping is the IP address [193. 168. 1.128] of the relay apparatus 1001. The servers 1005 and 1006, and the virtual servers 10071 and 10072 each return an echo reply packet with respect to the received ping, to the relay apparatus 1001 (S1107 to 1110). The echo reply packet transmitted from the server 1005 to the relay apparatus 101 includes a MAC address allocated to the server 1005. Similarly, the echo reply packet transmitted from each of the server 1006, and the virtual servers 10071 and 10072 to the relay apparatus 101 includes a MAC address allocated to a respective one of the server 1006, and the virtual servers 10071 and 10072. After having extracted the MAC addresses of the server 1006, and the virtual servers 10071 and 10072 from the respective echo reply packets, the relay apparatus 1001 discards these echo reply packets.

When the relay apparatus 1001 determines that there exists no MAC address overlapping with the source MAC address [00: 21: 33: 44: 55: 66] of the ARP request packet, in the network system 1000, the relay apparatus 1001 transmits the ARP request packet to each of the server 1005 and 1006, and the virtual server 10071 and 10072 without converting the source MAC address [00: 21: 33: 44: 55: 66] (S1111 to S1114).

Each of the virtual servers 10042, 10071 and 10072, and the servers 1005 and 1006 determines whether its own IP address is the IP address [193. 168. 1.126] included in the ARP request packet. The virtual server 10071 determines the IP address [193. 168. 1.126] is the IP address of the virtual server 10071 itself, and returns an ARP reply packet to the virtual server 10041 via the relay apparatuses 1003, 1002, and 1001 (S1115). The relay apparatuses 1003 and 1001 convert neither of the destination MAC address [00: 21: 33: 44: 55: 66] and the source MAC address [00: 21: 33: 44: 55: 60] (the MACA address of the virtual server 10071) that are included in the ARP reply packet, into another MAC address. This is because the relay apparatuses 1001 and 1003 have determined that there exists no overlapping addresses in the network system 1000.

The virtual server 10041 acquires the MAC address [00: 21: 33: 44: 55: 60] of the virtual server 10071, and records the MAC address [00: 21: 33: 44: 55: 60] of the virtual server 10071 in the ARP table 1600 to thereby update it. The virtual server 10041 transmits a packet to the virtual server 10071 with the MAC address [00: 21: 33: 44: 55: 60] as a destination address, and performs communications with the virtual server 10071 (S1116). The virtual server 10071 also performs communications with the virtual server 10041 with the MAC address [00: 21: 33: 44: 55: 66] as a destination address (S1117).

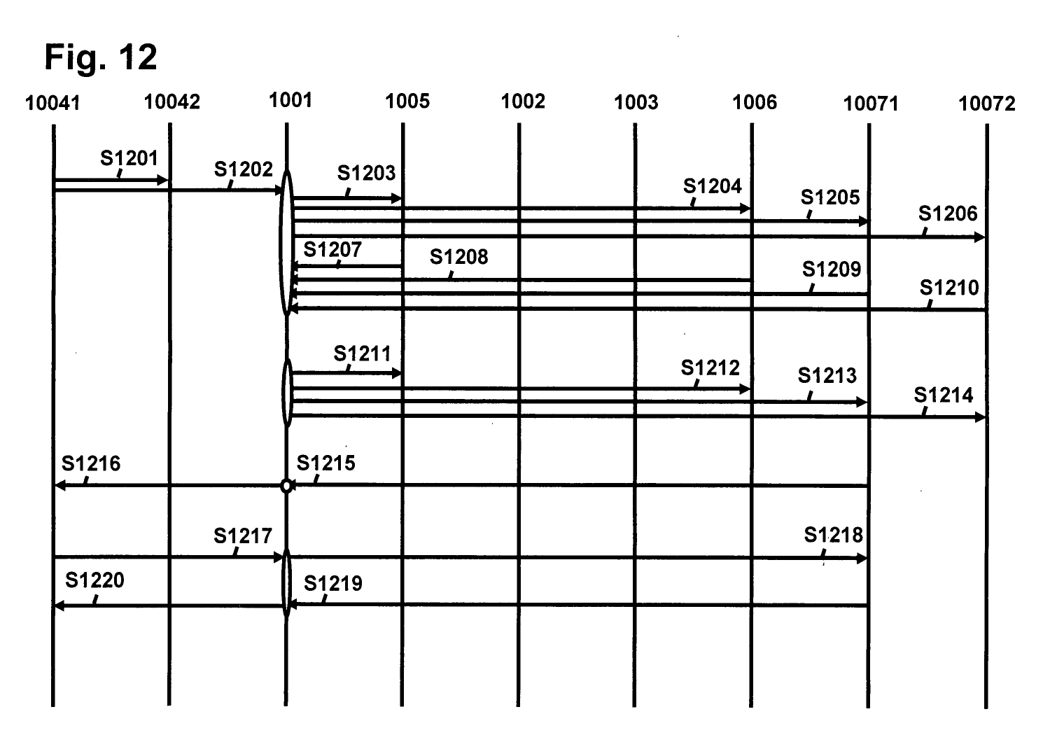

FIG. 12 is a sequence diagram of communications in the network system 1000 according to this embodiment. This figure is a sequence diagram in the case where a MAC address is overlapped. An instance is described in which the MAC address of the virtual server 10041 and that of the virtual server 10071 overlap with each other.

When the server 1004 is connected and communication is to be started, ARP processing is performed. The virtual server 10041 makes reference to the ARP table 1600. The MAC address of the virtual server 10071 has not been recorded in the ARP table 1600, and so the virtual server 10041 transmits, by broadcast, an ARP request packet to each of the virtual servers 10042, 10071, and 10072, and the servers 1005 and 1006 in the network system 1000 (S1201 and S1202). The ARP request packet includes information on the IP address [193. 168. 1.126] of the virtual server 10071 with which communication is desired to be performed, the IP address [193. 168. 1.122] of the virtual server 10041 as a source, and the MAC address [00: 21: 33: 44: 55: 66] of the virtual server 10041.

The servers 1005 and 1006, and the virtual servers 10071 and 10072 receive the ARP request packet via the relay apparatus 1001. Prior to transmitting the ARP request packet to the servers 1005 and 1006, and the virtual servers 10071 and 10072, the relay apparatus 1001 transmits a ping to each of the servers 1005 and 1006, and the virtual servers 10071 and 10072 (S1203 to 1206). Here, the purpose of transmitting the ping is to check whether the source MAC address [00: 21: 33: 44: 55: 66] (the MAC address of the virtual server 10041) included in the ARP request packet is overlapped in the network system 1000. Also, the source IP address of the ping is the IP address [193. 168. 1.128] of the relay apparatus 1001.

The servers 1005 and 1006, and the virtual servers 10071 and 10072 each return an echo reply packet with respect to the received ping, to the relay apparatus 1001 (S1207 to 1210). The echo reply packet transmitted from the server 1005 to the relay apparatus 101 includes a MAC address allocated to the server 1005. Similarly, the echo reply packet transmitted from each of the server 1006, and the virtual servers 10071 and 10072 to the relay apparatus 101 includes a MAC address allocated to a respective one of the server 1006, and the virtual server 10071 and 10072. After having extracted the MAC addresses of the server 1006, and the virtual servers 10071 and 10072 from the respective echo reply packets, the relay apparatus 1001 discards these echo reply packets.

When the relay apparatus 1001 determines that there exists a MAC address overlapping with the source MAC address [00: 21: 33: 44: 55: 66] of the ARP request packet, in the network system 1000, the relay apparatus 1001 converts the source MAC address [00: 21: 33: 44: 55: 66] of the ARP request packet into [01: 21: 33: 44: 55: 66]. Then, the relay apparatus 1001 transmits the ARP request packet to each of the server 1005 and 1006, and the virtual servers 10071 and 10072 with [01: 21: 33: 44: 55: 66] as a source MAC address (S1211 to S1214).

Each of the virtual servers 10042, 10071 and 10072, and the servers 1005 and 1006 determines whether its own IP address is the IP address [193. 168. 1.126] included in the ARP request packet.

The virtual server 10071 determines [193. 168. 1.126] is the IP address of the virtual server 10071 itself, and returns an ARP reply packet to the virtual server 10041 via the relay apparatuses 1003, 1002, and 1001 (S1215).

The ARP reply packet transmitted by the virtual server 10071 includes the source MAC address [00: 21: 33: 44: 55: 66] and the destination MAC address [01: 21: 33: 44: 55: 66]. Upon receipt of the ARP reply packet, the relay apparatus 1001 converts the source MAC address [00: 21: 33: 44: 55: 66] into [00: 21: 33: 44: 55: 60], and converts the destination MAC address from [01: 21: 33: 44: 55: 66] into [00: 21: 33: 44: 55: 66]. Then, the relay apparatus 1001 transmits the ARP reply packet to the virtual server 10041 (S1216).

The virtual server 10041 acquires the MAC address [00: 21: 33: 44: 55: 60] of the virtual server 10071, and records the MAC address [00: 21: 33: 44: 55: 60] of the virtual server 10071 in the ARP table 1600 to thereby update it. The virtual server 10041 transmits a packet to the virtual server 10071 with [00: 21: 33: 44: 55: 66] as a source address, and with [00: 21: 33: 44: 55: 60] as a destination MAC address (S1217). The relay apparatus 1001 converts the source address from [00: 21: 33: 44: 55: 66] into [01: 21: 33: 44: 55: 66], and converts the destination MAC address from [00: 21: 33: 44: 55: 60] into [00: 21: 33: 44: 55: 66], to thereby transmit a packet to the virtual server 10071 (S1218). The virtual server 10071 transmits a packet to the virtual server 10041 with [00: 21: 33: 44: 55: 66] as a source address and with [01: 21: 33: 44: 55: 66] as a destination MAC address (S1219). The relay apparatus 1001 converts the source address from [00: 21: 33: 44: 55: 66] into [00: 21: 33: 44: 55: 60], and converts the destination MAC address from [00: 21: 33: 44: 55: 66] into [00: 21: 33: 44: 55: 60], to thereby transmit a packet to the virtual server 10041 (S1220).

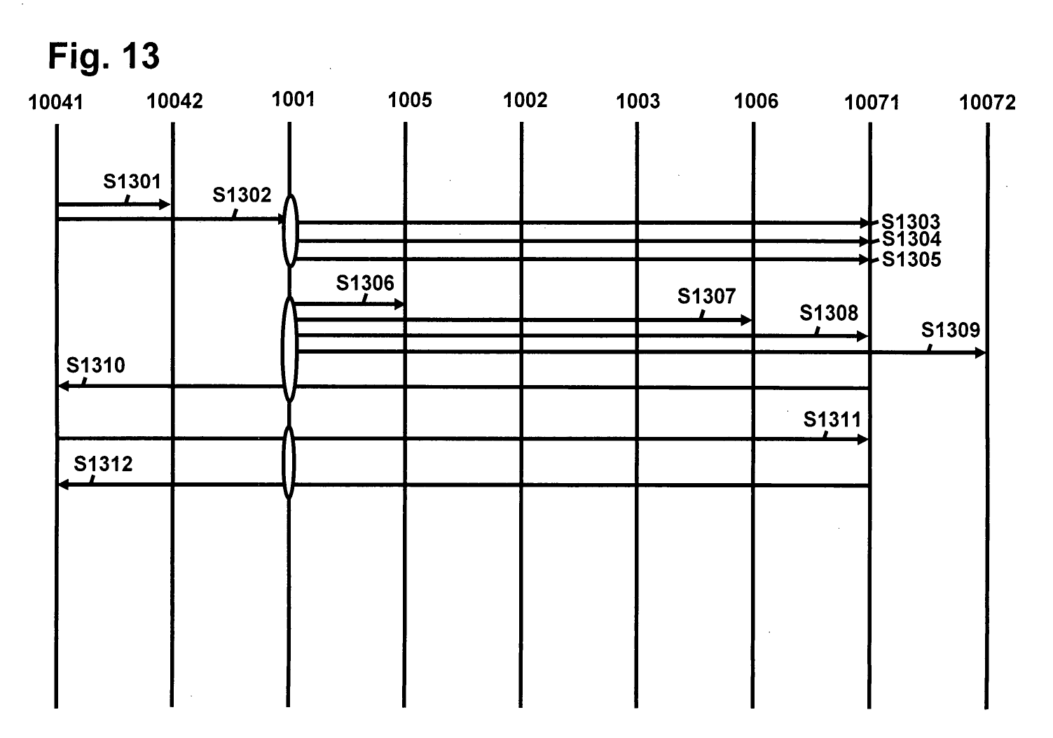

FIG. 13 is a sequence diagram of communications in the network system 1000 according to this embodiment. This is a sequence diagram in the case where there is no overlap of MAC address in the network system 1000, and the relay apparatus 1001 has already recognized the MAC address of a communication target server. Specifically, this is the case where the MAC address of the communication target server has been recorded in the MAC address table.

In this embodiment, the virtual server 10041 performs packet communications with the virtual server 10071. That is, the communication target server of the virtual server 10041 is the virtual server 10071.

Although the relay apparatus 1001 has the MAC address of the virtual server 10071 as the communication target server, it checks whether the virtual server 10071 actually exists, and the MAC address is overlapped. In other words, the relay apparatus 1001 checks whether the MAC address of the virtual server 10071, owned by the relay apparatus 1001 exists in the network system 1000.

In this embodiment, when the server 1004 is connected and communication is to be started, ARP processing is performed. First, the virtual server 10041 makes reference to the ARP table 1600. The MAC address of the virtual server 10071 has not been recorded in the ARP table 1600, and so the virtual server 10041 transmits, by broadcast, an ARP request packet to each of the virtual servers 10042, 10071, and 10072, and the servers 1005 and 1006 in the network system 1000 (S1301 and S1302). The ARP request packet includes information on the IP address [193. 168. 1.126] of the virtual server 10071 with which communication is desired to be performed, the IP address [193. 168. 1.122] of the virtual server 10041 as a source, and the MAC address [00: 21: 33: 44: 55: 66] of the virtual server 10041.

The servers 1005 and 1006, and the virtual servers 10071 and 10072 receive the ARP request packet via the relay apparatus 1001. Prior to transmitting the ARP request packet to the servers 1005 and 1006, and the virtual servers 10071 and 10072, the relay apparatus 1001 transmits a ping to each of the server 100 and the virtual server 10071 (S1303). Here, the purpose of transmitting the ping is to check whether the source MAC address [00: 21: 33: 44: 55: 66] (the MAC address of the virtual server 10041) included in the ARP request packet overlaps with the MAC address of the virtual server 10071 in the network system 1000. So, the ping is transmitted to the virtual server 10071 by unicast. The relay apparatus 1001 has already recognized the MAC address and the IP address of the virtual server 10071 before receiving the ARP request packet from the virtual server 10041. The relay apparatus 1001 determines that the MAC address [00: 21: 33: 44: 55: 66] of the virtual server 10041 is identical to the MAC address of the virtual server 10071. With this being the case, the relay apparatus 1001 checks by the transmission of the ping whether the MAC address of the virtual server 10071 is [00: 21: 33: 44: 55: 66].

The source IP address of the ping is the IP address [193. 168. 1.128] of the relay apparatus 1001, the destination IP address of the ping is the IP address [193. 168. 1.126] of the virtual server 10071, and the destination MAC address thereof is [00: 21: 33: 44: 55: 66]. When the relay apparatus 1001 does not receive an echo reply packet with respect to the ping even after a predetermined time has elapsed, it again transmits the ping to the virtual server 10071 (S1304). The virtual server 10071 herein returns an echo reply packet to the relay apparatus 1001 when the destination IP address and the destination MAC address conform to the above-described respective addresses. When the relay apparatus 1001 has not yet received an echo reply packet, it again transmits the ping to the virtual server 10071 (S1305). When the relay apparatus 1001, nevertheless, has not yet received an echo reply packet, it determines that the virtual server 10071 has moved outside the network system 1000 or that has moved to another physical port. In this embodiment, the transmissions of a ping are performed three times, but the number of transmissions is not limited to three times. If the relay apparatus 1001 transmits a ping predetermined times and receives no echo reply packet, the relay apparatus 1001 determines that there exist no overlapping MAC address in the network system 1000.

The relay apparatus 1001 transmits the ARP request packet to each of the server 1005 and 1006, and the virtual server 10071 and 10072 without converting the source MAC address [00: 21: 33: 44: 55: 66] (S1306 to S1309).

Each of the virtual servers 10042 and 10072, the new virtual server 10071, and the servers 1005 and 1006 determines whether its own IP address is the IP address [193. 168. 1.126] included in the ARP request packet.

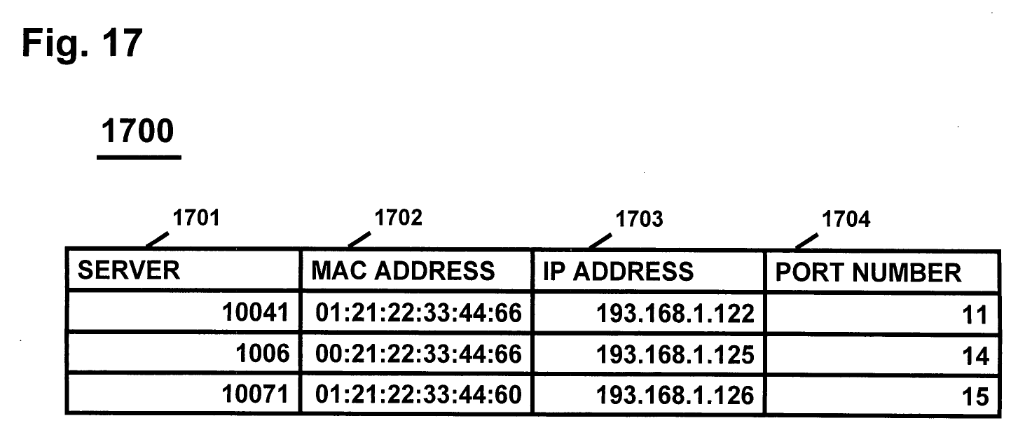

The new virtual server 10071 determines that [193. 168. 1.126] is its own IP address, and returns an ARP reply packet to the virtual server 10041 via the relay apparatuses 1003, 1002, and 1001 (S1310). Here, the new virtual server refers to a virtual server having a MAC address corresponding to the IP address [193. 168. 1.126] that has been recorded in the relay apparatus 1001. The relay apparatuses 1003 and 1001 convert neither of the destination MAC address [00: 21: 33: 44: 55: 66] and the source MAC address [00: 21: 33: 44: 55: 60] (the MAC address of the new virtual server 10071) that are included in the ARP reply packet into other MAC addresses. This is because the relay apparatuses 1001 and 1003 have determined that there exists no overlapping addresses in the network system 1000. The relay apparatuses 1001 and 1003 update a MAC address corresponding to the IP address [193. 168. 1.126] to [00: 21: 33: 44: 55: 60], and record it in a MAC address table 1700. Here, FIG. 17 is the MAC address table 1700 according to this embodiment. The MAC address table is a table showing the correspondence relationship between the post-conversion address and the port number that identifies each of the servers and the virtual servers connected to a relay apparatus having the MAC address table.

The virtual server 10041 acquires the MAC address [00: 21: 33: 44: 55: 60] of the virtual server 10071, and records the MAC address [00: 21: 33: 44: 55: 60] of the virtual server 10071 in the ARP table 1600 to thereby update it. The virtual server 10041 transmits a packet to the virtual server 10071 with the MAC address [00: 21: 33: 44: 55: 60] as a destination address, and performs communications with the virtual server 10071 (S1311). The virtual server 10071 also performs communications with the virtual server 10041 with the MAC address [00: 21: 33: 44: 55: 66] as a destination address (S1312).

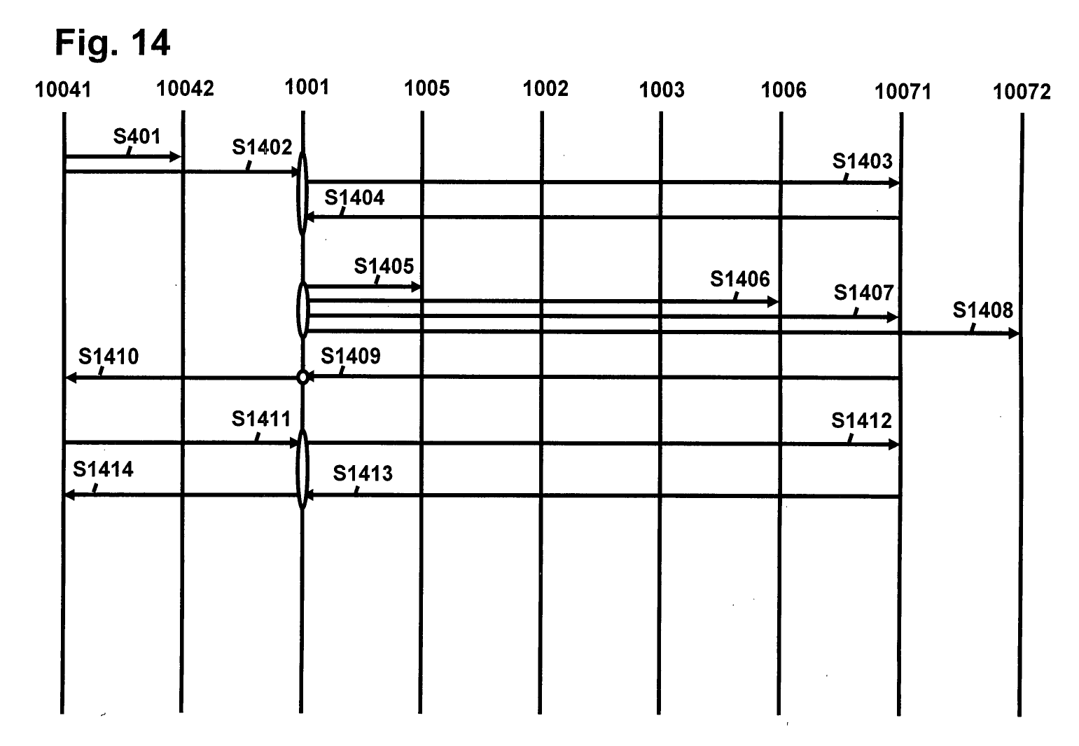

FIG. 14 is a sequence diagram of communications in the network system 1000 according to this embodiment. This is a sequence diagram in the case where there is no overlap of MAC address in the network system 1000, and the relay apparatus 1001 has already recognized the MAC address of a communication target server. Specifically, the MAC address of the communication target server has been recorded in the MAC address table 1700.

In this embodiment, the virtual server 10041 performs packet communications with the virtual server 10071. That is, the communication target server of the virtual server 10041 is the virtual server 10071. Although the relay apparatus 1001 has the MAC address of the virtual server 10071 as the communication target server, it checks whether the virtual server 10071 actually exists, and the MAC address is overlapped.

In this embodiment, when the server 1004 is connected and communication is to be started, ARP processing is performed. First, the virtual server 10041 makes reference to the ARP table 1600. The MAC address of the virtual server 10071 has not been recorded in the ARP table 1600, and so the virtual server 10041 transmits, by broadcast, an ARP request packet to each of the virtual servers 10042, 10071, and 10072, and the servers 1005 and 1006 in the network system 1000 (S1401 and S1402). The ARP request packet includes information on the IP address [193. 168. 1.126.] of the virtual server 10071 with which communication is desired to be performed, the IP address [193. 168. 1.122] of the virtual server 10041 as a source, and the MAC address [00: 21: 33: 44: 55: 66] of the virtual server 10041.

The servers 1005 and 1006, and the virtual servers 10071 and 10072 receive the ARP request packet via the relay apparatus 1001. Prior to transmitting the ARP request packet to the servers 1005 and 1006, and the virtual servers 10071 and 10072, the relay apparatus 1001 transmits a ping to each of the server 100 and the virtual server 10071 (S1403). Here, the purpose of transmitting the ping is to check whether the source MAC address [00: 21: 33: 44: 55: 66] (the MAC address of the virtual server 10041) included in the ARP request packet overlaps with the MAC address of the virtual server 10071 in the network system 1000. So, the ping is transmitted to the virtual server 10071 by unicast. The relay apparatus 1001 has already recognized the MAC address and the IP address of the virtual server 10071 before receiving the ARP request packet from the virtual server 10041. The relay apparatus 1001 determines that the MAC address [00: 21: 33: 44: 55: 66] of the virtual server 10041 is identical to the MAC address of the virtual server 10071. With this being the case, the relay apparatus 1001 checks by the transmission of the ping whether the MAC address of the virtual server 10071 is [00: 21: 33: 44: 55: 66].

The source IP address of the ping is the IP address [193. 168. 1.128] of the relay apparatus 1001, the destination IP address the ping is the IP address [193. 168. 1.126] of the virtual server 10071, and the destination MAC address thereof is [00: 21: 33: 44: 55: 66]. When the relay apparatus 1001 receives an echo reply packet with respect to the ping, the virtual server 10071 returns the echo reply packet to the relay apparatus 1001 (S1404). The virtual server 10071 herein returns an echo reply packet to the relay apparatus 1001 when the destination IP address and the destination MAC address are conform to the above-described respective addresses.

When the relay apparatus 1001 determines that there exists a MAC address overlapping with the source MAC address [00: 21: 33: 44: 55: 66] of the ARP request packet, in the network system 1000, the relay apparatus 1001 converts the source MAC address [00: 21: 33: 44: 55: 66] of the ARP request packet into [01: 21: 33: 44: 55: 66].

Then, the relay apparatus 1001 transmits the ARP request packet to each of the servers 1005 and 1006, and the virtual servers 10071 and 10072 with [01: 21: 33: 44: 55: 66] as a source MAC address (S1405 to S1408).

Each of the virtual servers 10042, 10071 and 10072, and the servers 1005 and 1006 determines whether its own IP address is the IP address [193. 168. 1.126] included in the ARP request packet.

The virtual server 10071 determines [193. 168. 1.126] is the IP address of the virtual server 10071 itself, and returns an ARP reply packet to the virtual server 10041 via the relay apparatuses 1003, 1002, and 1001 (S1409).

The ARP reply packet transmitted by the virtual server 10071 includes the source MAC address [00: 21: 33: 44: 55: 66] and the destination MAC address [01: 21: 33: 44: 55: 66]. Upon receipt of the ARP reply packet, the relay apparatus 1001 converts the source MAC address [00: 21: 33: 44: 55: 66] into [00: 21: 33: 44: 55: 60], and converts the destination MAC address from [01: 21: 33: 44: 55: 66] into [00: 21: 33: 44: 55: 66]. Then, the relay apparatus 1001 transmits the ARP reply packet to the virtual server 10041 (S1410).

The virtual server 10041 acquires the MAC address [00: 21: 33: 44: 55: 60] of the virtual server 10071, and records the MAC address [00: 21: 33: 44: 55: 60] of the virtual server 10071 in the ARP table 1600 to thereby update it. The virtual server 10041 transmits a packet to the virtual server 10071 with [00: 21: 33: 44: 55: 66] as a source address, and with [00: 21: 33: 44: 55: 60] as a destination MAC address (S1411). The relay apparatus 1001 converts the source address from [00: 21: 33: 44: 55: 66] into [01: 21: 33: 44: 55: 66], and converts the destination MAC address from [00: 21: 33: 44: 55: 60] into [00: 21: 33: 44: 55: 66], to thereby transmit a packet to the virtual server 10071 (S1412). The virtual server 10071 transmits a packet to the virtual server 10041 with [00: 21: 33: 44: 55: 66] as a source address and with [01: 21: 33: 44: 55: 66] as a destination MAC address (S1413). The relay apparatus 1001 converts the source address from [00: 21: 33: 44: 55: 66] into [00: 21: 33: 44: 55: 60], and converts the destination MAC address from [00: 21: 33: 44: 55: 66] into [00: 21: 33: 44: 55: 60], to thereby transmit a packet to the virtual server 10041 (S1414).

[Hard Configuration of Relay Apparatus 1001]

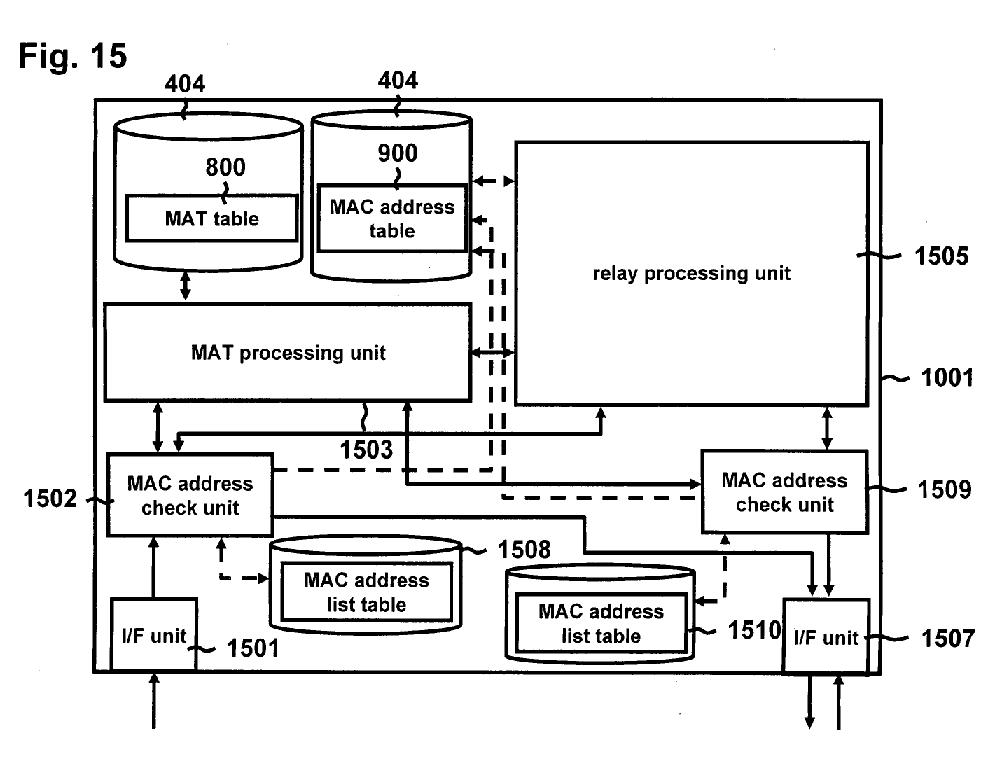

FIG. 15 is a hard block diagram of the relay apparatus 1001 according to this embodiment.

The relay apparatus 1001 comprises: an interface (I/F) units 1501 and 1507; MAC address check units 1502 and 1509; a MAT processing unit 1503; storage units 1504, 1506, 1508, and 1510; and a relay processing unit 1505.

The relay apparatus 101 receives a packet in the interface (I/F) unit 1501. The interface (I/F) unit 1501 receives packets from the virtual server 10041, 10042, 10071, and 10072, and the servers 1005 and 1006. The I/F unit 1501 transfers received packets to the MAC address check unit 1502.

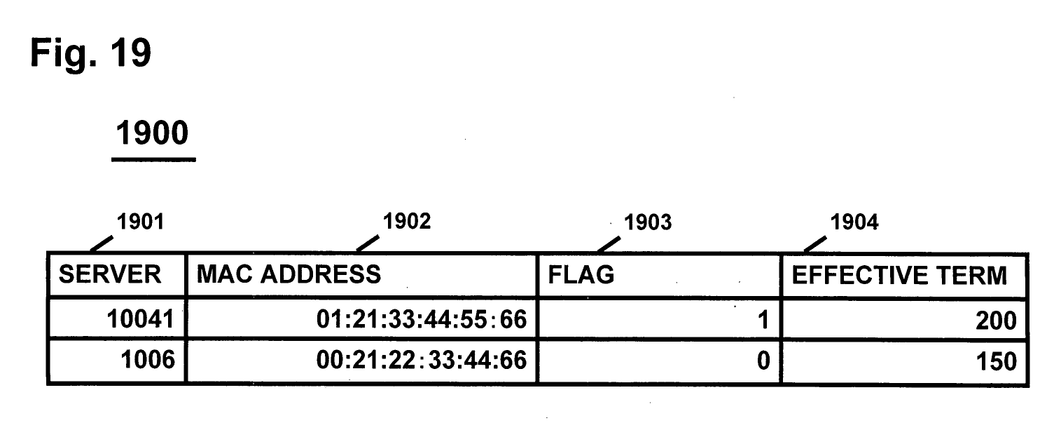

The MAC address check unit 1502 makes reference to a MAC address list table 1900 stored in the storage unit 1508. The MAC address list table 1900 shows whether a MAC address is a MAT target. FIG. 19 is a MAC address list table 1900. The MAC address list table 1900 shows the correspondence relationships between MAC addresses shown in the MAC address column 1901 and target flags shown in the target flag column 1902. That is, the target flag corresponding to the MAC address [01: 21: 22: 33: 44: 55] of the virtual server 10041 is [1], and the MAC address [01: 21: 22: 33: 44: 55] is a MAT target. On the other hand, the target flag corresponding to the MAC address [00: 21: 22: 33: 44: 66] of the server 1006 is [0], and this MAC address is non-MAT target.

The MAC address check unit 1502 transfers a packet having the MAC address that has been determined as being a MAT target in the MAC address list table 1900, to the MAT processing unit 1503. The MAC address check unit 1502 transfers a packet having the MAC address that has been determined as being a non-MAT target in the MAC address list table 1900, to the relay processing unit 1505.

When the MAC address of a packet to be relayed has not been recorded in the MAC address list table 1900, the MAC address check unit 1502 transfers the packet to the relay processing unit 1505. Then, the relay processing unit 1505 makes reference to the MAC address table 1700 restored in the storage unit 1506. When the MAC address of the packet has not been recorded in the MAC address table 1700, the relay processing unit 1505 generates a ping to be transmitted to each of the servers and virtual servers in the network. The relay apparatus 1001 transmits the ping to each of the servers and virtual servers in the network via the I/F unit 1507. Each of the servers and the virtual servers returns an echo reply packet to the relay apparatus 1001. The relay apparatus 1001 receives the echo reply packets via the I/F unit 1507. The I/F unit 1507 transfers the echo reply packets to the relay processing unit 1505. The relay processing unit 1505 transfers the echo reply packets to the MAC address check unit 1502. The MAC address check unit 1502 extracts MAC addresses included in the echo reply packet, and records them in the MAC address list table 1900. The MAT target flag corresponding to a MAC address that has been determined as being not overlapped, out of the extracted MAC addresses, is taken as [1]. The relay processing unit 1505 records MAC addresses included in the echo reply packet, in the MAC address table 1700. After having extracted the MAC addresses included in the echo reply packet, the MAC address check unit 1502 discards the echo reply packet.

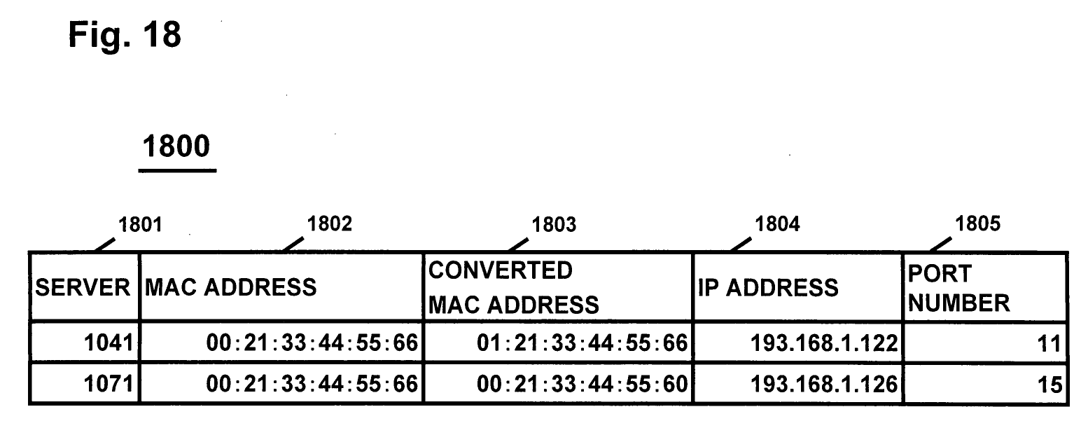

Then, in the updated MAC address list table 1900, when the MAT target flag corresponding to the source MAC address of the packet is [1], the MAT processing unit 1503 transfers the packet to the MAT processing unit 1503. The MAT processing unit 1503 makes reference to a MAT table 1800, and converts the source address located in the header portion of the packet. FIG. 18 is the MAT table according to this embodiment.

In the MAT table 1800, when the MAC address corresponding to the MAC address of a conversion target has been recorded, the MAT processing unit 1503 converts the source MAC address of the packet into a MAC address to be converted based on the MAT table 1800. If there exists no MAC address to be converted in the MAT table 1800, the MAT processing unit 1503 generates a MAC address to be converted. The MAT processing unit 1503 transmits a packet with the source address converted, to the relay processing unit 1505. The relay processing unit 1505 transmits the packet to a server or a virtual server having a destination MAC address via the I/F unit 1507.

In the updated MAC address list table, when the MAT target flag corresponding to the source MAC address of the packet is [0], the MAT processing unit 1503 transfers the packet to the MAT processing unit 1505. The relay processing unit 1505 transmits the packet to a server or a virtual server having a destination MAC address, via the I/F unit 1507.

As well as performing conversion processing with respect to MAC addresses, the MAT processing unit 1503 records, in the MAT table 1800, IP addresses corresponding to MAT addresses before conversion, MAC addresses after conversion, and MAC addresses that are subjected to the conversion processing. Here, the recording of MAC addresses or the like in the MAT table 1800, to be performed by the MAT processing unit 1503 is conducted when the pertinent MAC addresses or the like have not been recorded in the MAT table 1800.

As a result, at a second time or later, the MAT processing unit 1503 can shorten conversion processing with respect to MAC addresses conversion processing with respect to MAC addresses by making reference to the MAT table 1800, which allows the conversion processing with respect to MAC address to be efficiently performed.

Likewise, the presence-absence of an overlap of the destination MAC address of a packet is performed by the MAC address check unit 1509 by making reference to the MAC address list table recorded in the storage unit 1510. The conversion of the destination MAC address of a packet is performed by the MAT processing unit 1503 as in the case the conversion of the source MAC address.

The relay apparatuses 1001, 1002, and 1003 may be configured so as to notify a management server (not shown) that a MAC address is overlapped in the network 1000, by utilizing the SNMP (simple network management protocol) or the like.

The processings performed by the address check units in the present invention is included in the processings performed by the MAC address check unit 1502 set forth in the present embodiment. Also, the processings performed by the address conversion units in the present invention are included in the processings performed by the MAT processing units. The processings performed by using the address request signals in the present invention are included in the processings performed using the pings in the present embodiment. The processings performed by using the correspondence information in the present invention are included in the processings performed using the echo reply packets in the present embodiment. The processings performed by using the address conversion tables in the present invention are included in the processings performed using the MAT tables in the present embodiments. The processings performed by the converted address designating units in the present invention are included in the processings performed by the MAT function on/off check units.

In this embodiment, the MAC address check units 1502 and 1509; the MAT processing unit 1503; and the relay processing unit 1505 have hard configurations physically different from one another, but processings performed by these units may be functionally implemented by a single hard. Also, in this embodiment, the MAC address table 1700, the MAT table 1800, and the MAC address list table 1900 are stored in the storage units 1504, 1506, 1508, and 1510 that are physically different from one another, but the MAC address table 1700, the MAT table 1800, and the MAC address list table 1900 may be stored in a single hard.

According to the present invention, by detecting that MAC addresses allocated to virtual servers mutually different in the relay apparatus overlap, and converting the MAC addresses into the MAC addresses owned by the respective relay apparatuses, it is possible to reliably establish communications even if a plurality of virtual servers having the identical MAC address exist in the network. Also, according to the present invention, even under the environment in which there is a high possibility that a MAC address is overlapped, high-reliability communications can be implemented without causing a communication failure.

What is claimed is:

1. A relay apparatus for relaying communications between information processing units in a network, the relay apparatus comprising:
an address check unit for checking for an overlap of an address allocated to each of a plurality of information processing units existing in the network;
an address conversion unit for converting the overlapped address detected by the address check unit to thereby create a post-conversion address; and
a relay processing unit for relaying communications between the information processing units on the basis of the post-conversion address.

2. The relay apparatus according to claim 1, wherein the address check unit generates an address request signal that requires an address for each of the information processing units existing in the network.

3. The relay apparatus according to claim 2, wherein the address check unit acquires an address of each of the information processing units from response information with respect to the address request signal.

4. The relay apparatus according to claim 3, wherein the address check unit discards the response information after having acquired the address of each of the information processing units from the response information.

5. The relay apparatus according to claim 4, wherein a source address of the response information is an IP address allocated to the relay apparatus.

6. The relay apparatus according to claim 5, wherein an address acquired from the response information by the address check unit is a MAC address.

7. The relay apparatus according to claim 1, further comprising:
a storage unit for storing an address conversion table that relates the overlapped address detected by the address check unit to the post-conversion address.

8. The relay apparatus according to claim 7, wherein the storage unit stores an address list table that records an address used for a relay of communication, and identification information indicating whether the address is a conversion target.

9. The relay apparatus according to claim 8, wherein the address check unit makes reference to the address list table to thereby check whether an address of each of the information processing units to be relayed is a conversion target.

10. The relay apparatus according to claim 9, wherein, when no address is recorded in the address list table, the relay apparatus generates an address request signal that requires an address for each of the information processing units.

11. A relay apparatus for relaying communications between information processing units in a network, the relay apparatus comprising:
a conversed address designating unit for designating an address to be converted, out of addresses allocated to a plurality of information processing units existing in the network;
an address conversion unit that converts the address designated by the conversed address designating unit to thereby create a post-conversion address;
a storage unit for storing an address conversion table that relates the address designated by the conversed address designating unit to the post-conversion address; and
a relay processing unit for relaying communications between the information processing units, on the basis of the post-conversion address.

12. The relay apparatus according to claim 11, wherein the storage unit stores an address table that indicates a correspondence relationship between the post-conversion address and a port number that identifies each of the information processing units connected to the relay apparatus; and
wherein the relay processing unit makes reference to the address table to thereby relay communications between the information processing units.

13. The relay apparatus according to claim 11, wherein, when the relay processing unit determines that there exist no addresses of the information processing units to be relayed, in the address table, the relay apparatus relays communications between the information processing units by using the addresses acquired from the address conversion unit.

14. A communication method for performing communications between information processing units in a network, the communication method comprising:
an address check step for checking for an overlap of an address allocated to each of a plurality of information processing units existing in the network;
an address conversion step for converting the overlapped address detected in the address check procedure to thereby create a post-conversion address; and
a relay processing step for relaying communications between the information processing units on the basis of the post-conversion address.
